(19) United States
(12) Patent Application Publication
(10) Pub. No.: US 2015/0168155 A1
(43) Pub. Date: Jun. 18, 2015

(54) METHOD AND SYSTEM FOR MEASURING A VEHICLE POSITION INDOORS

(71) Applicant: HYUNDAI MOTOR COMPANY, Seoul (KR)

(72) Inventor: Byung Yong You, Suwon (KR)

(21) Appl. No.: 14/463,002

(22) Filed: Aug. 19, 2014

(30) Foreign Application Priority Data
Dec. 18, 2013 (KR) 10-2013-0158399

(51) Int. Cl. G01C 21/20; G08G 1/056; H04N 7/18; G08G 1/123

(52) U.S. Cl. CPC G01C 21/206; G08G 1/123; G08G 1/056; H04N 7/183

(57) ABSTRACT

A method and system for measuring a vehicle position indoors are provided. The method includes continuously determining, by a controller, whether a vehicle is present within a range captured by a closed circuit television (CCTV). When the vehicle is present within that range, the controller is configured to calculate the vehicle position on a map using an image result of the vehicle captured the CCTV and calculate a heading angle which is a running direction of the vehicle. In addition, an absolute position of the vehicle on the map is calculated using the vehicle position on the map and the heading angle.

### CROSS-REFERENCE TO RELATED APPLICATION

This application is based on and claims priority from Korean Patent Application No. 10-2013-0158399, filed on Dec. 18, 2013 in the Korean Intellectual Property Office, the disclosure of which is incorporated herein in its entirety by reference.

### BACKGROUND

1. Field of the Invention

The present invention relates to a method and system for measuring a vehicle position indoors, and more particularly, to a method for measuring a vehicle position indoors using an imaging device within a vehicle and a closed circuit television (CCTV) without an expensive light detection and ranging (LiDAR) sensor and the like.

2. Description of the Prior Art

As is well known, a global positioning system (GPS) is a device that recognizes and determines the three-dimensional coordinate value corresponding to the position of the GPS receiver using the three or more GPS satellites. However, since the sensing of a position is possible only in an outdoor environment, indoor positioning or determining a position in the area of a shadow blocked by buildings may not be possible. In other words, in an environment such a room, since the application of GPS is difficult, positioning technology of a new method is required.

Furthermore, research on important precision in the field of position measuring has been conducted. In particular, contributing significantly to the accuracy of the position measurement is a non line of sight (NLOS) issue. The position measurement in wireless environments is influenced by many environmental factors due to the nature of radio waves. Although line of sight (LOS) radio waves environment is an essential element for the high accuracy, in the actual environment, the direct path may be disturbed by many factors. An important disturbance factor is path loss, multipath propagation, NLOS and the like. Due to these disturbance factors, problems such as reflection and diffraction of radio waves occur, and as a result, the length of the path is longer and thus the difficulty for accurate position measurement may occur.

### SUMMARY

The present invention provides a method and system for measuring a vehicle position indoors using an imaging device disposed within a vehicle and CCTV without an expensive LiDAR sensor and the like. In addition, the present invention provides a method for measuring a vehicle position indoors to be used to derive the vehicle control parameters for attended valet parking and indoor autonomous driving.

A method for measuring a vehicle position indoors according to an exemplary embodiment of the present invention may include determining whether a vehicle exists in a range captured by CCTV; returning to the determination process while the vehicle continuously runs when the vehicle is not present within range captured by the CCTV, and calculating the vehicle position on a map using an image result that captures the vehicle by the CCTV when the vehicle is present within a range captured by CCTV; calculating a heading angle which is a running direction of the vehicle; and calculating an absolute position of the vehicle on the map using the vehicle position on the map and the heading angle.

According to an exemplary embodiment of the present invention, the position of the CCTV and a specific point on the map have an absolute position value for the map. In addition, the process of calculating the position includes extracting a vanishing point for the running direction of the vehicle; extracting a center position of an imaging device disposed within the vehicle; and calculating a horizontal bias of the vehicle using the vanishing point and the center position of the imaging device. The step of calculating the position also includes calculating the position of the vehicle on the map, using the image result capturing the vehicle by the CCTV and the absolute position value for the map of the position of the CCTV.

Further, after the calculation of the position, of the method includes calculating a first absolute coordinate which is the exact position of the vehicle for the map using the horizontal bias and the vehicle position on the map. Additionally, after the calculation of the position, of the method includes calculating a second absolute coordinate which is the exact position of the vehicle for the map through the horizontal bias and an absolute position value for the map of a specific point on the map.

The method further includes verifying a reliability of the exact position of the vehicle for the map, by comparing the first absolute coordinate with the second absolute coordinate. After verifying the reliability of the exact position of the vehicle for the map, of the method includes deriving a control parameter for operating the vehicle. Accordingly, a method for measuring a vehicle position indoors according to the present invention may include measuring a vehicle position indoors using an imaging device disposed within a vehicle and CCTV without an expensive LiDAR sensor and the like. The method may also include measuring a vehicle position indoors to be used to derive the vehicle control parameters for attended valet parking and indoor autonomous driving.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram showing an indoor CCTV, a specific marking point and the absolute position coordinates in a method for measuring a vehicle position indoors according to an exemplary embodiment of the present invention;

FIG. 2 is an exemplary diagram showing a process of calculating the horizontal bias in a method for measuring a vehicle position indoors according to an exemplary embodiment of the present invention;

FIG. 3 is an exemplary diagram showing a process of calculating the vehicle heading angle in a method for measuring a vehicle position indoors according to an exemplary embodiment of the present invention;

FIG. 4 is an exemplary diagram showing specific steps included in a method for measuring a vehicle position indoors according to an exemplary embodiment of the present invention;

FIG. 5 is an exemplary diagram concretely showing steps of calculating the center position of the vehicle in a method for measuring a vehicle position indoors according to an exemplary embodiment of the present invention; and

FIG. 6 is an exemplary diagram showing specific steps included in a method for measuring a vehicle position indoors according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The advantage and features of the present invention and how to achieve it will be explained through exemplary embodiments described in detail with the accompanying drawings. However, the invention is not limited to the exemplary embodiments described herein and may be embodied in other aspects. The present exemplary embodiment is provided for explaining to those skilled in the art to which this invention pertains in detail to the extent that it is possible to easily embody the technical spirit of the present invention. In the drawings, exemplary embodiments of the present invention are not limited to the shown specific aspects and are exaggerated in order to clarify. Although specific terms are used herein, it is only used for explaining the present invention, and it is not used for limiting the meaning or the scope of the present invention described in the claims.

In a conventional system, the relatively exact vehicle position in several of m˜several tens of m may be recognized using GPS. However, since the measurement method using the GPS system is merely possible in outdoor environments, when measuring the position indoors or measuring the position in the area of the shadow blocked by buildings, it may not be possible to use the conventional method. Recently, although a navigation system also estimates and complements the vehicle position indoors in some degree using Dead Reckoning, the error resulting from such a method is substantial and the duration for position measurement is relatively short. Accordingly, to implement the technology for operating a vehicle in an indoor parking lot (e.g., a garage or the like), specially, the technology such as the automatic valet parking, a method capable of consistently and more accurately measuring the vehicle position is required.

As a system for the automatic valet parking described above, a longitudinal parking system has been developed and a technology capable of angle parking has been researched as well. In particular, in currently researched methods, a driver exits the vehicle at the entrance to the indoor parking lot, the driver provides an instruction for the automatic valet parking using smart phone, the vehicle autonomously drive the inside of the parking lot, and parks in a vacant space, and transfers the parking completion status to the smart phone.

Additionally, the same research has been conducted for automatically exiting a parking space. For operating the vehicle, the required technology is to accurately measure the vehicle position indoors. However, the conventional automatic valet parking system has a limit point which must install expensive LiDAR sensors throughout the parking lot floor to measure the vehicle position within the garage or other indoor space. Without installing expensive LiDAR sensors described above throughout the parking lot floor, the present invention may measure the vehicle position indoors using the existing installed CCTV and the absolute coordinates capable of being specified for each location of the parking lot.

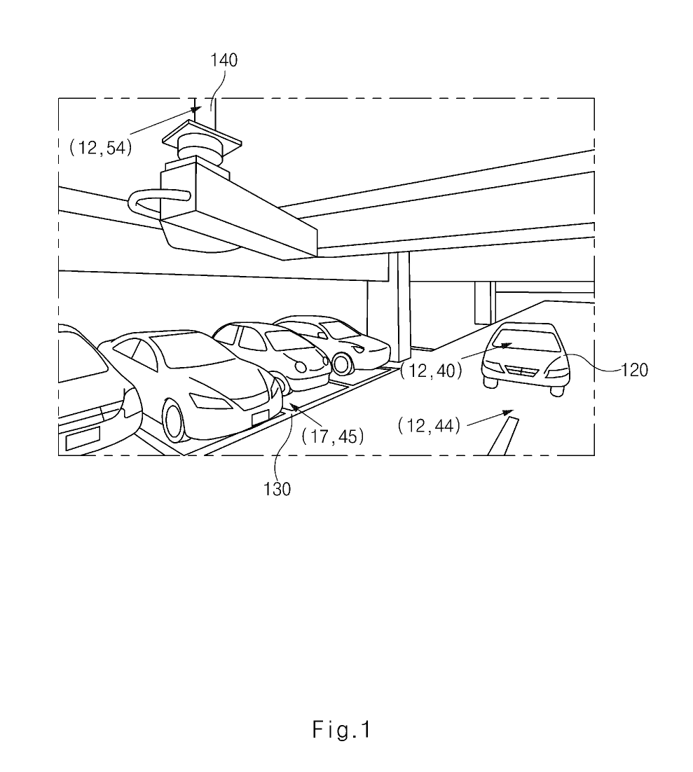

Moreover, FIG. 1 is an exemplary diagram showing an indoor CCTV, a specific marking point and the absolute position coordinates in a method for measuring a vehicle position indoors according to an exemplary embodiment of the present invention. First, the CCTV 140 may have a coordinate value of (12, 54) as an absolute position value for the map, and the parking line 130, which is a specific point (e.g., a specific marking point), may have coordinate values of (17, 45) and (12, 44) as an absolute position value for the map. In addition, the vehicle 120 as a target for measuring the position may have a coordinate value of (12, 40) as an absolute position value. By this indoor absolute position coordination, the indoor position of the vehicle may be measured via the surrounding structures (e.g., CCTV and specific marking point).

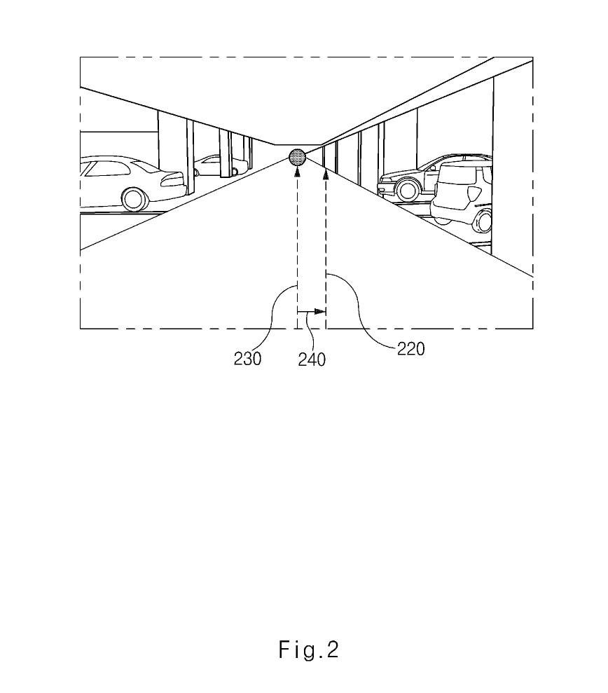

FIG. 2 is an exemplary diagram showing a process of calculating the horizontal bias in a method for measuring a vehicle position indoors according to an exemplary embodiment of the present invention. The process illustrated in FIG. 2 may be executed by a controller. First, the vanishing point 210, 230 for the driving direction of the traveling vehicle may be extracted. In particular, the vanishing point may be extracted based on the indoor parking reference line. Additionally, the center position 220 of the imaging device disposed within the vehicle may be extracted. Thereafter, through the extracted vanishing point 210, 230 and the center position 220 of the imaging device, the horizontal bias 240 of the vehicle may be calculated.

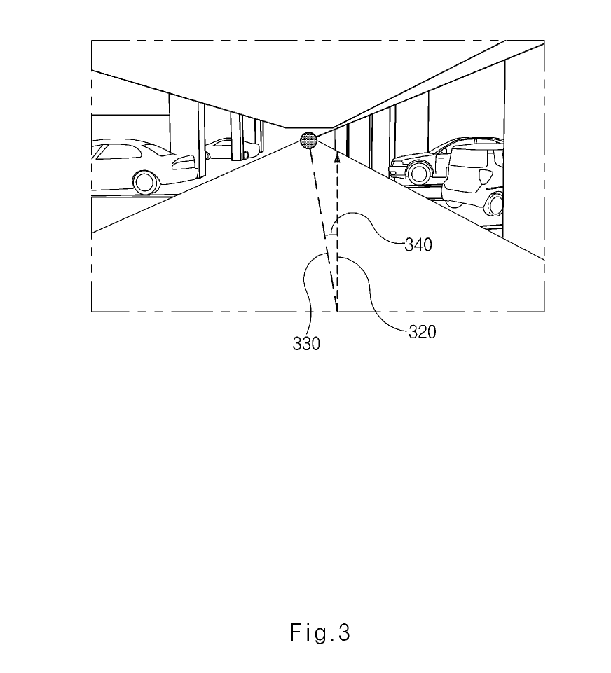

FIG. 3 is an exemplary diagram showing a process of calculating, by a controller, the vehicle heading angle in a method for measuring a vehicle position indoors according to an exemplary embodiment of the present invention. First, using the calculated vanishing point 310, 330 and the center position 320 of the imaging device, the heading angle 340, which is the heading direction of the vehicle, may be calculated by the controller. Through FIGS. 2 and 3, by the calculated horizontal bias 240 and the heading angle 340, the running direction (e.g., the traveling direction) and current position of the vehicle may be more accurately measured.

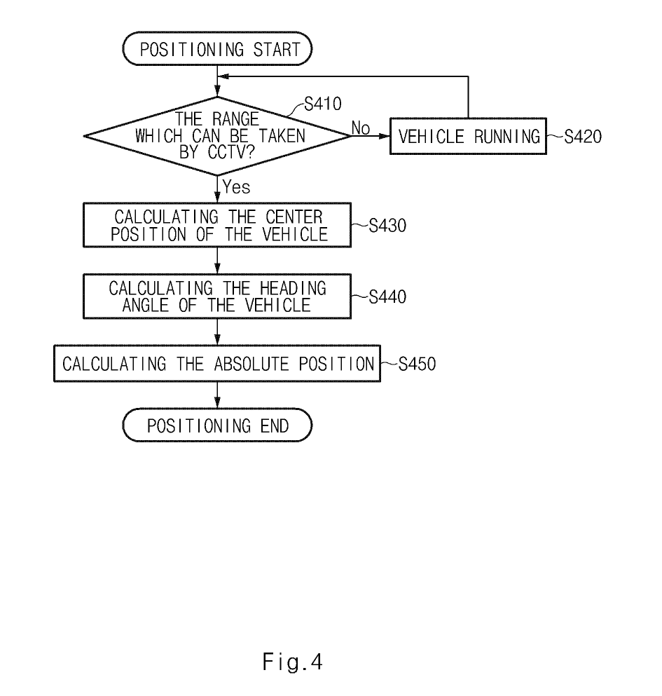

FIG. 4 is an exemplary diagram showing specific steps included in a method for measuring a vehicle position indoors according to an exemplary embodiment of the present invention. Referring to FIG. 4, the method for measuring the vehicle position indoors may include step S410 through step S450. In particular, the controller may be configured to determine whether the vehicle is present (e.g., is located) within a range captured by CCTV S410. The purpose of the present invention, which is different from the conventional automatic valet parking system and the method for measuring the vehicle position indoors thereof, is to use a CCTV disposed indoors (e.g., inside of a building, garage, or the like). Therefore, the controller may be configured to determine whether the vehicle for calculating the position may be an imaging object of CCTV.

As the result of the determination at step S410, when the vehicle is not present within the range captured by the CCTV, the vehicle may continuously run (e.g., travel) until the vehicle is within the range captured by the CCTV S420. In addition, when the vehicle is present within the range captured by the CCTV, determined using the image result of the vehicle by CCTV, the controller may be configured to calculate the vehicle position on the indoor map on which the vehicle is running S430. In particular, since two-dimensional coordinates are used as the method for specifying the position on the indoor map, the vehicle position may be also calculated by two-dimensional coordinates, and the coordinates located in about the center of the vehicle may be the position coordinates of the vehicle.

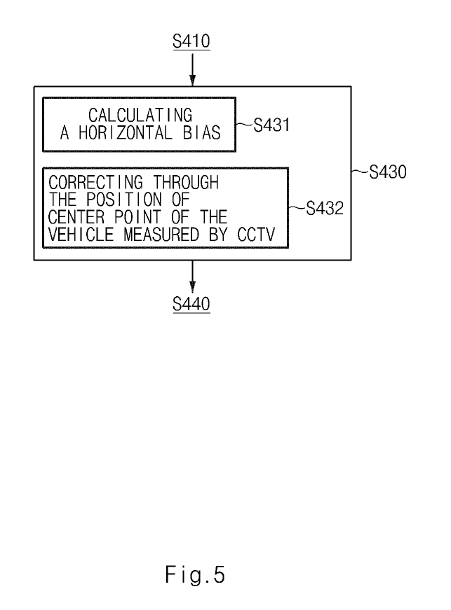

Thereafter, the heading angle representing the running direction of the vehicle described in FIG. 3 may be calculated S440. Additionally, using the vehicle position on the map calculated in step S430 and the heading angle of the vehicle calculated in step S440, the absolute position (absolute coordinate) on the indoor map may be calculated S450. In particular, step S430 will be explained in detail with reference to FIG. 5 which is an exemplary diagram showing steps of calculating the center position of the vehicle in a method for measuring a vehicle position indoors according to an exemplary embodiment of the present invention.

Moreover, Step S430 for calculating the center position of the vehicle, as described in FIG. 2, may include calculating, by the controller, a horizontal bias of the vehicle S431. Thereafter, by comparing the calculated horizontal bias with the vehicle position calculated by CCTV, more accurate vehicle position may be calculated S432. In particular, the process, which compares and calculates at step 432, may correct the horizontal bias using the center position of the vehicle measured by CCTV, and may correct the center position of the vehicle using the horizontal bias. After step S430 of calculating the center position of the vehicle, the method for measuring the vehicle position indoors may further include calculating, by the controller, about the exact position of the vehicle for indoor map using the horizontal bias calculated in step S431 and the absolute position value for the map of the specific point (e.g., specific marking point) on the map as described in FIG. 1.

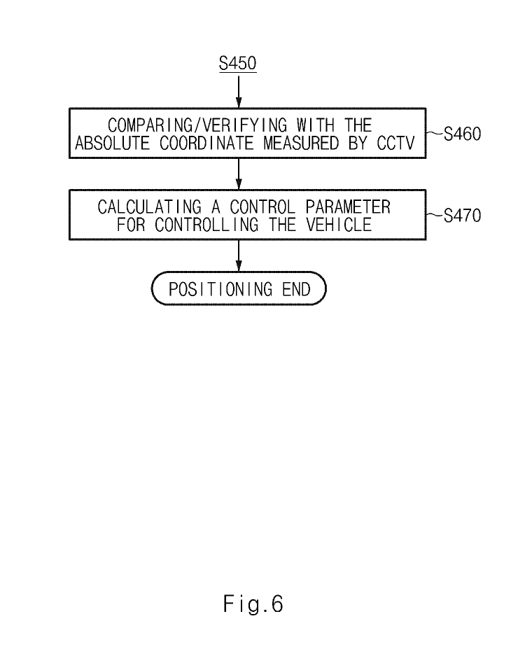

FIG. 6 is an exemplary diagram showing steps included in a method for measuring a vehicle position indoors according to another exemplary embodiment of the present invention. Referring to FIG. 6, the method for measuring the vehicle position indoors may further include step S460 and step S470 together with step S410 through S450. In particular, by comparing/verifying the substantially exact position of the vehicle for the map calculated using the horizontal bias and CCTV with the exact position of the vehicle for the map calculated using the horizontal bias and the absolute position of the specific point (e.g., specific marking point), the reliability for the exact position of the vehicle may be verified S460. Additionally, after verifying the reliability of the exact position of the vehicle for the map at S460 step, the control parameters for operating the vehicle such as an automatic valet parking system may be derived S470.

As described above, the method for measuring the vehicle position indoors according to the present invention may measure the position of the vehicle traveling indoors using an already existing CCTV disposed indoors, an inside imaging device disposed within a vehicle, and the coordinate values of an indoor map. As the result, it may be possible to measure the vehicle position more accurately without previously required expensive equipment, and the vehicle control parameters for indoor automatic valet parking may be derived. Further, an indoor parking lot has been described as a specific example of the present invention, but when merely a CCTV is present, an inside imaging device and map coordinate as a constitution for embodying the present invention, it may be applied in the shadow area which causes GPS error such as an outdoor parking lot and an alley as well as indoor area.

In the above description, the present invention has been described through specific examples, but it may be well understood that various modifications can be made without departing from the scope of the present invention. Therefore, the scope of the present invention is not limited to the above described exemplary embodiments, and it should be defined by the appended claims and their equivalents. When taking the foregoing description into account, if the modifications and variations of the present invention fall within the following claims and their equivalents, then it is construed that the present invention includes these modifications and variations.

What is claimed is:

1. A method for measuring a vehicle position indoors, comprising:
continuously determining, by a controller, whether a vehicle is present within a range captured by a closed circuit television (CCTV) while the vehicle is traveling;
calculating, by the controller, the vehicle position on a map using an image result of the vehicle captured by the CCTV when the vehicle is present within range captured by CCTV;
calculating, by the controller, a heading angle which is a traveling direction of the vehicle; and
calculating, by the controller, an absolute position of the vehicle on the map using the vehicle position on the map and the heading angle.

2. A method for measuring a vehicle position indoors according to claim 1, wherein the position of the CCTV and a specific point on the map have an absolute position value for the map.

3. A method for measuring a vehicle position indoors according to claim 2, wherein the calculating of the position includes:
extracting, by the controller, a vanishing point for the traveling direction of the vehicle;
extracting, by the controller, a center position of an imaging device disposed within the vehicle; and
calculating, by the controller, a horizontal bias of the vehicle using the vanishing point and the center position of the imaging device.

4. A method for measuring a vehicle position indoors according to claim 3, wherein the calculating of the position includes:
calculating, by the controller, the position of the vehicle on the map, using the image result of the vehicle captured by the CCTV and the absolute position value for the map of the position of the CCTV.

5. A method for measuring a vehicle position indoors according to claim 4, further comprising after calculating the vehicle position:
calculating, by the controller, a first absolute coordinate which is the exact position of the vehicle for the map using the horizontal bias and the vehicle position on the map.

6. A method for measuring a vehicle position indoors according to claim 5, further comprising after calculating the vehicle position:
calculating, by the controller, a second absolute coordinate which is the exact position of the vehicle for the map using the horizontal bias and an absolute position value for the map of a specific point on the map.

7. A method for measuring a vehicle position indoors according to claim 6, further comprises:
verifying, by the controller, a reliability of the exact position of the vehicle for the map, by comparing the first absolute coordinate with the second absolute coordinate.

8. A method for measuring a vehicle position indoors according to claim 7, further comprising:
deriving, by the controller, a control parameter for operating the vehicle.

9. A system for measuring a vehicle position indoors, comprising:
a memory configured to store program instructions; and
a processor configured to execute the program instructions, the program instructions when executed configured to:
continuously determine whether a vehicle is present within a range captured by a closed circuit television (CCTV) while the vehicle is traveling;
calculate the vehicle position on a map using an image result of the vehicle captured by the CCTV when the vehicle is present within range captured by CCTV;
calculate a heading angle which is a traveling direction of the vehicle; and
calculate an absolute position of the vehicle on the map using the vehicle position on the map and the heading angle.

10. The system of claim 9, wherein the position of the CCTV and a specific point on the map have an absolute position value for the map.

11. The system of claim 9, wherein the program instructions when executed are further configured to:
extract a vanishing point for the traveling direction of the vehicle;
extract a center position of an imaging device disposed within the vehicle; and
calculate a horizontal bias of the vehicle using the vanishing point and the center position of the imaging device.

12. The system of claim 11, wherein the program instructions when executed are further configured to:
calculate the position of the vehicle on the map, using the image result of the vehicle captured by the CCTV and the absolute position value for the map of the position of the CCTV.

13. The system of claim 12, wherein the program instructions when executed are further configured to:
calculate a first absolute coordinate which is the exact position of the vehicle for the map using the horizontal bias and the vehicle position on the map.

14. The system of claim 13, wherein the program instructions when executed are further configured to:
calculate a second absolute coordinate which is the exact position of the vehicle for the map using the horizontal bias and an absolute position value for the map of a specific point on the map.

15. The system of claim 14, wherein the program instructions when executed are further configured to:
verify a reliability of the exact position of the vehicle for the map, by comparing the first absolute coordinate with the second absolute coordinate.

16. The system of claim 15, wherein the program instructions when executed are further configured to:
derive a control parameter for operating the vehicle.

17. A non-transitory computer readable medium containing program instructions executed by a controller, the computer readable medium comprising:
program instructions that continuously determine whether a vehicle is present within a range captured by a closed circuit television (CCTV) while the vehicle is traveling;
program instructions that calculate the vehicle position on a map using an image result of the vehicle captured by the CCTV when the vehicle is present within range captured by CCTV;
program instructions that calculate a heading angle which is a traveling direction of the vehicle; and
program instructions that calculate an absolute position of the vehicle on the map using the vehicle position on the map and the heading angle.

18. The non-transitory computer readable medium of claim 17, wherein the position of the CCTV and a specific point on the map have an absolute position value for the map.

19. The non-transitory computer readable medium of claim 17, further comprising:
program instructions that extract a vanishing point for the traveling direction of the vehicle;
program instructions that extract a center position of an imaging device disposed within the vehicle; and
program instructions that calculate a horizontal bias of the vehicle using the vanishing point and the center position of the imaging device.

20. The non-transitory computer readable medium of claim 19, further comprising:
program instructions that calculate the position of the vehicle on the map, using the image result of the vehicle captured by the CCTV and the absolute position value for the map of the position of the CCTV.
